(19) United States
(12) Patent Application Publication
(10) Pub. No.: US 2025/0346462 A1
(43) Pub. Date: Nov. 13, 2025

(54) DEVICE AND METHOD FOR MONITORING A CABLE WINCH

(71) Applicant: Liebherr-Werk Nenzing GmbH, Nenzing (AT)

(72) Inventors: Patrick JUSSEL, Ludesch (AT); Falk NÜBEL, Nenzing (AT)

(21) Appl. No.: 19/176,837

(22) Filed: Apr. 11, 2025

(30) Foreign Application Priority Data
May 8, 2024 (DE) 10 2024 112 998.0

(51) Int. Cl. B66D 1/36; B66D 1/48; B66D 1/54

(52) U.S. Cl. CPC B66D 1/36; B66D 1/485; B66D 1/54

(57) ABSTRACT

The disclosure relates to a device for monitoring the winding behaviour of a cable, comprising a cable winch with a rotatable cable drum on which the cable is mounted so that it can be wound and unwound, at least one sensor unit configured to capture a recording of two-dimensional images of cable coils on the cable drum, and an analysis unit configured to receive the recording from the at least one sensor unit, define at least two different analysis regions in the recording, each representing at least one cable coil in whole or in part, and analyse these independently of one another for the presence of a faulty cable winding. The disclosure also relates to a working machine, such as a crane, civil engineering machine, or cable excavator, having the device, a method for monitoring the winding behaviour of the cable, and a corresponding computer program product.

### CROSS REFERENCE TO RELATED APPLICATION

The present application claims priority to German Patent Application No. 10 2024 112 998.0 filed on May 8, 2024. The entire contents of the above-listed application are hereby incorporated by reference for all purposes.

### TECHNICAL FIELD

The present disclosure relates to a method for monitoring the winding behaviour of a cable on a cable winch, and a corresponding monitoring method and a computer program product.

### BACKGROUND

Cable winches with cable drums for storing, unwinding and winding cables are known from the prior art in countless variants and for numerous functions. For example, working machines are often equipped with cable winches that can be used to operate hoisting cables for lifting or lowering loads or cable tensioners for moving booms or boom parts. Due to the high cable forces, care must be taken to ensure defined and smooth cable winding on working machines of this type. For this purpose, it is known, for example, to provide the drum body with a groove that not only determines the geometric orientation of the first cable winding layer lying directly on the groove, but in the case of cable winches with multi-layer winding also influences the cable winding layers above it and guides their cable coils in a targeted manner. To ensure correct winding and unwinding of the cable and even force distribution, it is important that neighbouring cable windings are directly adjacent to each other, i.e. without gaps and without cable skipping.

The operator of such a working machine must therefore pay constant attention to correct winding behaviour, in particular when winding multiple layers on the cable drum. Incorrect winding behaviour can result in expensive damage. This can damage the cable or the winch, making repairs necessary and causing downtime.

To ensure correct winding behaviour, devices are known in which the cable drum is captured by a camera and a corresponding image is displayed to the operator on a monitor in the driver's cab. However, faulty windings are not always reliably recognised by the operator. In addition, the reliability of such monitoring depends on the attention and experience of the operator.

### SUMMARY

The object of the present disclosure is therefore to further develop generic devices for monitoring the winding behaviour of such cable winches in such a way that winding errors are detected more reliably.

According to the disclosure, this object is achieved by a device with the features described herein, by a method with the features described herein, and by a computer program product with the features described herein.

Accordingly, a device for monitoring the winding behaviour of a cable on a cable winch is proposed, which device comprises a cable winch with a rotatable cable drum on which a cable can be wound and unwound. The cable winch is optionally a multi-layer winch, in which several layers of cable are wound on top of each other. The cable drum can have grooves on its upper side, for example a LeBus or sinusoidal groove, for defined guidance of the cable winches. The cable winch can be a hoisting cable winch or a tensioning winch for a working machine. The cable winch can have a drive for bidirectional rotational driving of the cable drum.

The device comprises at least one sensor unit (e.g. a camera), which captures two-dimensional recordings of cable coils on the cable drum. The at least one sensor unit may have a recording range that covers the entire cable drum. There can be exactly one sensor unit, or a plurality of sensor units that record recordings of cable coils on the cable drum from different angles.

According to the disclosure, the device comprises an analysis unit, which receives the recording from the at least one sensor unit and is configured to define at least two different analysis regions in the recordings and to analyse these independently of one another for the presence of a faulty cable winding. The analysis regions, which can also be referred to as regions of interest (ROI), each map at least one cable coil in whole or in part, wherein the different analysis regions optionally map at least partially different portions of the cable coils and/or different cable coils.

The analysis regions are evaluated by the analysis unit using a suitable algorithm or a plurality of algorithms. The algorithm(s) used to detect winding errors can be based on machine learning methods and can optionally be trained to recognise the monitored cable drum or typical winding errors for this type of cable drum. This enables more reliable automated fault detection that is not based on the attention or experience of a human operator.

The segmentation of the monitored winding image into a plurality of analysis regions enables the precise monitoring of different winding errors that are typical for the respective cable winding layer or drum regions. For example, gaps or cable skips in a cable winding layer can be easily recognised at the radial edge areas, while a stacking of a plurality of cable coils is more likely to occur at the axial end portions of the cable drum, in the region of the typical axial boundary walls. Furthermore, the cable entry point (i.e. the point at which the cable exits tangentially from the cable drum) can be monitored in a targeted manner.

The term ‘faulty cable winding’ is not limited to faults within a cable winding layer, but can also include a fault or an impermissible deviation of a cable portion running out from the cable drum (e.g. running out at the wrong angle or cable flutter).

The analysis regions can be defined on the basis of fixed parameters stored, for example, in the analysis unit or a memory unit connected thereto, such that the ‘definition’ can also simply consist of an application or consideration of fixed image areas or parameters.

In one possible embodiment, it is provided that at least one sensor unit is a camera (e.g. a black-and-white camera or a colour camera) that captures two-dimensional images of cable coils on the cable drum. A plurality of cameras can record images from different angles in order to monitor winding errors on a larger circumferential area of the cable drum.

As an alternative or in addition to one or a plurality of cameras, another type of sensor unit such as LIDAR can be used.

In a further possible embodiment, it is provided that the recording direction of at least one sensor unit is perpendicular to an axis of rotation of the cable drum. This results in a top view of the imaged side of the cable drum, wherein the recording direction optionally intersects the axis of rotation of the cable drum. Optionally, the recording direction is at an angle and thus not parallel to a cable portion running tangentially from the cable drum, for example at a vertical angle, so that a top view of the running cable portion is obtained, which allows angular deviations to be recognised particularly well.

Alternatively, the recording direction of at least one sensor unit could also be at an angle deviating from 90° to the axis of rotation of the cable drum, so that said sensor unit ‘looks at’ the cable drum at an angle. This could be advantageous for the detection of certain winding errors. There can be a plurality of sensor units that are aligned at different angles to the cable drum.

In another possible embodiment, it is provided that an analysis region comprises a radial edge region of the imaged cable drum and extends over the entire axial length of the cable drum. As a result, all cable coils in the top cable coil layer are detected in the area in which they ‘dip’ behind the curvature of the cable drum as seen by the sensor unit. This area is particularly good for detecting gaps and/or cable skips between the cable coils. The analysis region optionally has a rectangular shape, but can in principle have any regular or irregular shape.

Optionally, two analysis regions are defined at the two opposite radial edge regions of the imaged cable drum and may each extend over the entire axial length of the cable drum. This allows gaps and/or cable skips between cable winches to be detected even more reliably. The analysis regions can have an identical shape.

In another possible embodiment, it is provided that an analysis region comprises a radial central region of the imaged cable drum and extends over the entire axial length of the cable drum. Optionally, the analysis region is selected such that it lies radially at the height of a cable entry point of a cable portion running tangentially from the cable drum. The cable entry point is the point on the cable drum or the top cable winding layer from which the cable is guided tangentially away from the cable drum. When unwinding and winding the cable, the cable entry point moves in an axial direction, e.g., parallel to the drum rotation axis along the cable drum. Optionally, the analysis region is selected so that the cable entry point lies within the analysis region in every winding situation. With this rectangular analysis region in particular, correct cable retraction can be monitored by detecting the cable entry point.

In a further possible embodiment, it is provided that the analysis unit is configured to keep one or more of the previously mentioned analysis regions constant during winding and unwinding of the cable in the recordings, e.g., not to change their arrangement and shape when winding and unwinding of the cable.

In another possible embodiment, it is provided that an analysis region comprises a cable portion running tangentially from the cable drum and extends along the cable portion extending from the cable drum. Optionally, the analysis region is selected so that it includes the running cable portion including the cable entry point. Optionally, this analysis region can be used to monitor the angle of entry of the cable and, if necessary, correct cable retraction. Alternatively or additionally, a movement of the running cable (e.g. cable flutter) can be monitored. The analysis region may have a rectangular shape, but can in principle have any regular or irregular shape.

Since the said cable portion runs from the cable drum at an angle to the drum rotation axis in particular, the analysis region can also extend at such an angle, e.g., parallel to the cable portion.

Since the cable entry point, and thus the tangentially extending cable portion, naturally moves in an axial direction along the cable drum when the cable is wound and unwound, the analysis unit is optionally configured to move the aforementioned analysis region along with the cable entry point, e.g., with the tangentially extending cable portion, in the recordings when winding and unwinding the cable. This ensures that the tangentially running cable portion does not move out of the relevant analysis region when winding or unwinding. The change or position of the analysis region can be determined using image processing methods from the recording itself and/or using data from at least one other sensor (e.g. an angle encoder or a sensor for recording the uncoiled cable length).

In another possible embodiment, it is provided that an analysis region comprises an end portion of a top cable winding layer on the imaged cable drum. This means that the end of the top cable winding layer lies in the analysis region mentioned. Optionally, the analysis region extends over the entire radial width of the cable drum in order to detect the entire last cable winch ‘visible’ from the viewing angle of the corresponding sensor unit. Alternatively or additionally, the analysis region can extend over a partial region of the axial length of the cable drum. In other words, the analysis region may not cover the entire top cable winding layer, but only its end region, which may include the cable entry point. This analysis region enables, in particular, the detection of so-called cable stacks at the ends of the cable drum (where axial boundary walls of the cable drum are usually located).

Since the axial end of the top cable winding layer naturally moves in an axial direction along the cable drum when the cable is wound and unwound, the analysis unit is optionally configured to move the aforementioned analysis region along with the end portion of the top cable winding layer, in the recordings when winding and unwinding the cable. This ensures that the end of the top cable winding layer does not move out of the analysis region when winding or unwinding. The change or position of the analysis region can be determined using image processing methods from the recording itself and/or using data from at least one other sensor (e.g. an angle encoder or a sensor for recording the uncoiled cable length).

Any combination of the analysis regions described above can be used in the device according to the disclosure.

In a further possible embodiment, it is provided that the analysis unit is configured to analyse, for example by means of a machine learning algorithm, the analysis regions for the presence of a gap between two adjacent cable coils, a cable skip, a faulty cable retraction, movements of a tangentially extending cable portion, a faulty cable departure angle and/or a cable stacking.

Alternatively or additionally, the analysis unit can be configured to analyse, for example by means of a machine learning algorithm, the analysis regions for the presence of a minimum number of cable coils. For example, it can be specified that there must always be at least three (or any other number of) safety coils on the cable drum.

Alternatively or additionally, the analysis unit can be configured to analyse, for example by means of a machine learning algorithm, the analysis regions to determine whether the number of cable layers has fallen below or exceeded a maximum number. If, for example, the operator of the working machine uses a cable that is too long, this can lead to damage to the cable drum walls (e.g., the axial boundary walls of the cable drum) if there are too many windings or cable layers on the cable drum.

Different algorithms can be used for different analysis regions. These can be analysed using different machine learning algorithms and/or based on different training data.

In another possible embodiment, it is provided that the analysis unit is configured to issue a warning via a display unit when a faulty cable winding is detected. This allows the operator of the working machine to be alerted to a deviation at an early stage so that they can intervene in good time and stop the cable winch, for example. Alternatively or in addition to a visual warning, an acoustic warning can be issued.

Optionally, the operator is shown a two-dimensional recording or an image of the at least one sensor unit on a monitor, which shows the current situation of the cable drum. This can be a live image or a live video stream. Optionally, the analysis unit can be configured to show an overlay of regions on this display in which a winding error has been detected. This allows the operator to be notified of such an error clearly and intuitively.

Alternatively or additionally, the analysis unit can be configured to issue a control command when a faulty cable winding is detected, for example to automatically intervene in the control of a drive of the cable winch (e.g. braking or stopping a current cable winch movement).

In another possible embodiment, it is provided that the analysis unit is configured to analyse, for example by means of a machine learning algorithm, the analysis regions both independently of each other and in combination for the presence of a faulty cable winding. In addition to independent analysis, the information from the individual analysis regions can also be combined with each other to further improve the reliability of error detection. This means that an error or deviation in relation to the cable entry point can simultaneously be reflected in an angular deviation of the cable portion running tangentially from the cable drum and vice versa.

In another possible embodiment, it is provided that the device comprises a lighting unit by means of which a portion of the cable drum detected by the at least one sensor unit can be illuminated. This minimises lighting errors (caused by sunlight and/or shadows, for example), which improves error detection.

In another possible embodiment, it is provided that the device comprises more than one cable winch, the winding images of which are recorded by one or more sensor units (e.g. cameras) and the recording data of which is analysed by the analysis unit in the manner described above. The number of cable winches can therefore be scaled as required. The cable winches and corresponding sensor units can be arranged at any number of different points on a working machine.

In another possible embodiment, it is provided that the analysis unit is configured to recognise a condition of the cable (e.g. damage patterns such as basket formation, strand breakage, pulling into deeper layers, etc.). This can be done using data from any analysis region or all analysis regions, or via a specially defined analysis region. It is advantageous to do this with the cable in the unwound position.

In another possible embodiment, it is provided that the cable winch comprises at least one further sensor (e.g. an angle sensor or a sensor for measuring the cable length) and its data is transmitted to the analysis unit. This makes it possible, for example, to monitor the expected position of the cable, as the expected cable position may depend on the angle of rotation of the cable winch or the unwound cable length. One or more analysis units can be defined or adapted using the data from the at least one additional sensor.

Alternatively or additionally, additional sensors can be used to detect the movement status of the cable drum (e.g. whether there is movement and in which direction) and/or to detect other faults (e.g. a cable skipping over a drum web only in the first cable layer, an evaluation of the cable layer via a cable length measurement, etc.).

The disclosure also relates to a working machine with a device according to the disclosure. This results in the same properties and advantages as for the device according to the disclosure as such, which is why a repetitive description is dispensed with. In particular, all the embodiments and features described above for the device according to the disclosure also apply to the working machine according to the disclosure, in any combination.

The working machine comprises a display unit on which recordings of the at least one sensor unit and/or information relating to a faulty cable winding recognised by the analysis unit can be displayed (for example as an overlay, as described above). A plurality of display units can be provided. A display unit can be arranged in a driver's cab of the working machine and/or designed as a mobile control device (e.g. tablet PC).

The working machine can be a stationary crane (e.g. a tower crane, offshore crane or ship crane), a mobile crane (e.g. a truck-mounted crane or a lattice boom crane), a deep foundation machine (e.g. a vibratory pile driver, a trench cutter or a rotary drilling rig), a cable excavator or any other working machine with at least one cable winch. The monitored cable winch can be a hoisting cable winch (e.g., for lifting and lowering a load) or a tensioning cable winch (e.g., for extending and retracting a cable tensioning).

The disclosure also relates to a method for monitoring the winding behaviour of a cable on a cable winch of a device according to the disclosure. Here, as already described with reference to the device according to the disclosure, two-dimensional recordings of cable coils are captured on a cable drum of the cable winch, wherein at least two different analysis regions, each depicting at least one cable coil in whole or in part, are defined in the recordings and these are analysed independently of one another for the presence of a faulty cable winding. This results in the same properties and advantages as for the device according to the disclosure, which is why a repetitive description of the individual properties and the possible optional embodiments of the method steps is dispensed with. All the embodiments and features described above for the device according to the disclosure also apply to the method according to the disclosure, in any combination.

The disclosure also relates to a corresponding computer program product for performing the method according to the disclosure, comprising instructions that, when the program is executed, cause the steps of the method described above relating to the control unit to be performed by the analysis unit of the device according to the disclosure. Optionally, the computer program product can be operated on conventional machine controls so that no retrofitting of hardware components is necessary. The computer program product can be part of an assistance system or represent such a system.

### BRIEF DESCRIPTION OF THE FIGURES

Further features, details and advantages of the disclosure result from the following exemplary embodiments explained with the help of the figures. In the drawings:

FIG. 1: shows a schematic representation of the device according to the disclosure according to an exemplary embodiment; and

FIG. 2: shows an exemplary embodiment of a recording of the cable winch having a plurality of analysis regions.

### DETAILED DESCRIPTION

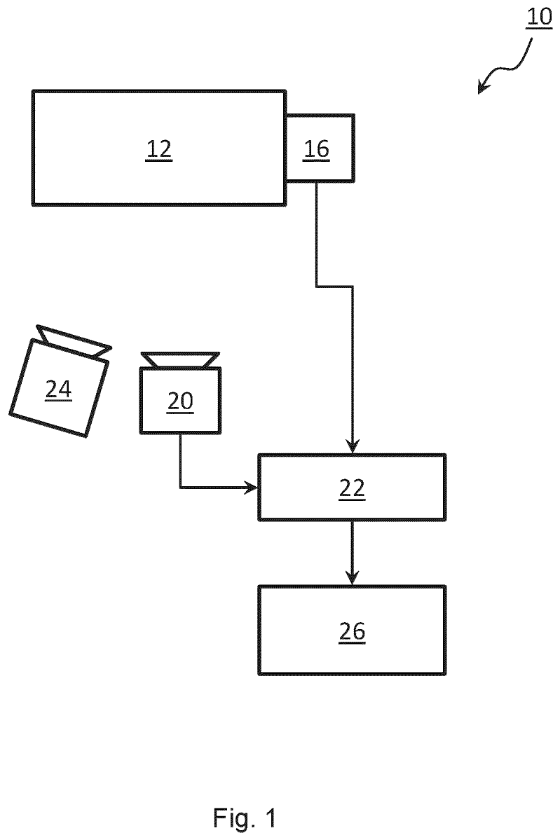

FIG. 1 shows an exemplary embodiment of the device 10 according to the disclosure in a schematic representation. The device 10 comprises a cable winch with a cable drum 12 that can be rotationally driven by a drive (not shown) and on which a cable (also not shown) is wound. This is optionally a cable winch with multi-layer winding, in which a plurality of cable winding layers lie on top of each other.

A sensor unit 20 (e.g., camera) captures the winding image of the cable on the cable drum 12 and takes images of the cable drum 12 and the cable wound thereon, wherein optionally the complete cable drum 12 is captured. A plurality of cameras and/or other sensor units such as a LIDAR system can be used to capture the winding image. The optical axis of the sensor unit 20 is optionally perpendicular to the axis of rotation of the cable drum 12.

An analysis unit 22 receives the image data from the sensor unit 20 and analyses it. The analysis unit 22 may be connected to at least one display unit 26, which may, for example, be arranged in a driver's cab of a working machine comprising the device 10.

Optionally, the device 10 can comprise a lighting unit 24 that illuminates the cable drum 12 or the cable winding in the detection range of the sensor unit 20 in order to improve the image quality and error detection and to minimise exposure errors (e.g. solar radiation, shadows cast).

Optionally, the device may comprise one or more further sensors 16 (e.g. an angle encoder or a cable length meter), the data of which may also be transmitted to the analysis unit 22 and used as a basis for the monitoring method, for example for the purpose of determining the position and/or size of one or more analysis regions. Furthermore, the further sensors 16 can be used to analyse other parameters in order to determine certain faults (cable skip, evaluation of the cable position, etc.).

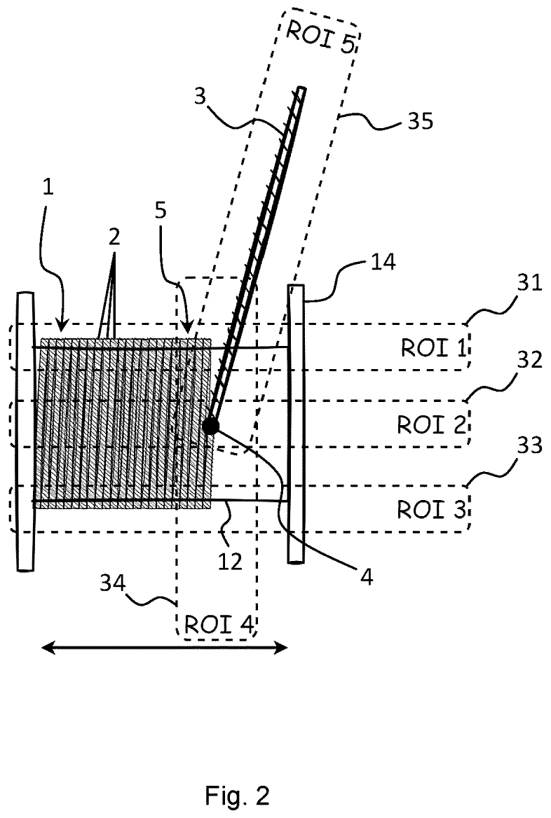

The analysis method carried out by the analysis unit 22 is explained in more detail below with reference to the exemplary embodiment shown in FIG. 2. FIG. 2 shows the cable drum 12 with the cable 1 wound up as seen by the sensor unit 20. The individual cable coils 2 can be seen. The cable 1 runs tangentially away from the cable drum 12 from a cable entry point 4 at one end region (on the right in FIG. 2) of the cable layer under consideration. Only the running cable portion 3 in the region of the cable drum 12 is shown. The angle of the tangentially running cable portion 3 can be mechanically predetermined by a guide device (not shown) in order to ensure controlled winding and unwinding of the cable 1 on the cable drum 12.

According to the disclosure, the analysis unit 22 does not (only) analyse the entire image supplied by the sensor unit 20 as a whole, but divides it into a plurality of image regions or analysis regions 31-35, which are examined separately for winding errors using corresponding algorithms.

A first analysis region 31 can be defined at a radial edge region (the upper edge in FIG. 2) of the cable drum 12 and extend over its entire axial length (the horizontal extent of the cable drum 12 in FIG. 2), so that all visible, e.g., overhead cable coils 2 lie in this optionally rectangular first analysis region 31. The first analysis region 31 optionally covers only a part of the cable drum width (i.e., the vertical extent of the cable drum 12 in FIG. 2). The first analysis region 31 enables effective detection of cable skips and/or gaps between the cable coils 2.

Optionally, a third analysis region 33, optionally identical to the first analysis region 31, is provided on the opposite radial edge (the lower edge in FIG. 2) of the cable drum 12 in order to improve the detection of gaps and/or cable skips.

A second analysis region 32 may extend in a central radial region of the cable drum 12 (e.g., parallel to and in the region of the axis of rotation of the cable drum 12) along the entire axial length of the cable drum 12. The second analysis region 32 optionally covers only a part of the cable drum width. The sensor unit 20 may be arranged and aligned such that the cable entry point 4 is always within the second analysis region 32 and moves within the second analysis region 32 when the cable 1 is wound and unwound. The latter thus enables monitoring of the correct cable retraction.

A fourth analysis region 34 can comprise an end portion 5 of the top cable winding layer on the cable drum 12 (in the case of a single cable winding layer, this is then the end portion of this cable winding layer). Said end portion 5 comprises one or more of the last cable coils 2 before the cable entry point 4. The fourth analysis region 34 may not extend over the entire axial length of the cable drum 12, but only over one or a few cable coils 2 of said end portion 5. The fourth analysis region 34 enables the detection of cable stacks on axial boundary walls 14 of the cable drum 12 (i.e., cable drum walls).

The fourth analysis region 34 optionally moves with the end portion 5 when the cable 1 is wound and unwound, for example parallel to the axis of rotation of the cable drum 12, i.e. in the axial direction (see double arrow in FIG. 2). The parameterisation of the fourth analysis region 34 is optionally carried out using a cable length measurement and/or an angle measurement of the cable drum 12 via at least one additional sensor 16.

A fifth analysis region 35 can extend along the tangentially running cable portion 3 and may also comprise the cable entry point 4. The fifth analysis region 35 makes it possible to detect whether the cable departure angle (i.e. the angle between the tangentially exiting cable portion 3 and the axis of rotation of the cable drum 12) is within a permissible range and/or whether there are impermissible movements of the cable (so-called cable flutter). The fifth analysis region 35 optionally moves with the cable entry point 4 or with the tangentially extending cable portion 3 when winding and unwinding the cable 1, for example parallel to the axis of rotation of the cable drum 12, i.e. in the axial direction. The parameterisation of the fifth analysis region 35 is optionally carried out using a cable length measurement and/or an angle measurement of the cable drum 12 via at least one additional sensor 16.

The analysis regions 31-35 shown are examples and can be used in any combination. However, they depend on the respective cable drum 12 and cable guide. Other analysis regions not shown in FIG. 2 are conceivable. Deviating from the rectangular analysis regions 31-35 shown in FIG. 2, these can also have a different shape.

The analysis regions 31-35 are analysed independently of each other, but optionally also in combination, by the analysis unit 22. The individual subsystems or analysis regions 31-35 are optionally evaluated using analysis algorithms based on machine learning methods or artificial intelligence.

If a winding error is detected in at least one analysis region 31-35, the operator may be shown corresponding information on the display unit 26 (e.g. in the form of a warning or an overlay on a camera or video image of the cable drum 12).

The sensor unit 20 optionally provides a video stream of the cable drum 12, which is displayed on the display unit 26. If a detected error is reported to the operator via the analysis unit 22, the operator can then check the winding behaviour directly on the video image from the camera stream. Optionally, an overlay of the image can highlight the area where the algorithm has detected a deviation or a winding error.

As an additional function, the analysing unit 22 can optionally determine whether a prescribed minimum number of cable coils (for example three) are ensured on the cable drum 12. If the number of safety coils is too low, the cable 1 could come loose from the cable drum 12. Alternatively or additionally, exceeding a maximum number of cable layers on the cable drum 12 can be monitored in order to prevent damage to the cable drum walls.

List of Reference Numerals:

| | |
|---|---|
| 1 | Cable |
| 2 | Cable coil |
| 3 | Tangentially running cable portion |
| 4 | Cable entry point |
| 5 | End portion of the top cable winding layer |
| 10 | Device |
| 12 | Cable drum |
| 14 | Axial boundary wall |
| 16 | Sensor(s) |
| 20 | Sensor unit |
| 22 | Analysis unit |
| 24 | Lighting unit |
| 26 | Display unit |
| 31 | First analysis region |
| 32 | Second analysis region |
| 33 | Third analysis region |
| 34 | Fourth analysis region |
| 35 | Fifth analysis region |

1. A device for monitoring a winding behaviour of a cable on a cable winch, comprising:
a cable winch with a rotatable cable drum on which a cable is mounted so that it can be wound and unwound,
at least one sensor unit configured to capture a recording of two-dimensional images of cable coils on the cable drum, and
an analysis unit, which receives the recording from the at least one sensor unit and is configured to define at least two different analysis regions in the recording, each representing at least one cable coil in whole or in part, and to analyse these independently of one another for the presence of a faulty cable winding.

2. The device according to claim 1, wherein the at least one sensor unit is a camera, which captures the two-dimensional images of the cable coils on the cable drum.

3. The device according to claim 1, wherein a recording direction of the at least one sensor unit is perpendicular to an axis of rotation of the cable drum.

4. The device according to claim 3, wherein an analysis region of the at least two different analysis regions comprises a radial edge region of the imaged cable drum and extends over the entire axial length of the cable drum.

5. The device according to claim 3, wherein an analysis region of the at least two different analysis regions comprises a radially central region of the imaged cable drum and extends over the entire axial length of the cable drum, wherein the analysis region is selected such that it lies radially at the level of a cable entry point of a cable portion extending tangentially from the cable drum.

6. The device according to claim 4, wherein the analysis unit is configured to keep the analysis region constant in the recording when winding and unwinding the cable.

7. The device according to claim 3, wherein an analysis region of the at least two different analysis regions comprises a cable portion extending tangentially from the cable drum and extends along the tangentially extending cable portion and/or at an angle to the axis of rotation of the cable drum, wherein the analysis unit is configured to move the analysis region together with the tangentially extending cable portion in the recordings when winding and unwinding of the cable.

8. The device according to claim 3, wherein an analysis region of the at least two different analysis regions comprises an end portion of a top cable winding layer on the imaged cable drum and extends over the entire radial width and/or only over a part of the axial length of the cable drum, wherein the analysis unit is configured to move the analysis region with the end portion of the top cable winding layer in the recording when winding and unwinding of the cable.

9. The device according to claim 1, wherein the analysis unit is configured to analyse, by means of a machine learning algorithm, the at least two different analysis regions for the presence of a gap between two adjacent cable coils, a cable skip, a faulty cable retraction, movements of a tangentially extending cable portion, a faulty cable departure angle, an undershoot of a minimum number of cable coils, an overshoot of a maximum number of cable layers and/or a cable stacking.

10. The device according to claim 1, wherein the analysis unit is configured to issue a warning via a display unit when a faulty cable winding is detected and/or to issue a control command for automatic intervention in a control system of the cable winch.

11. The device according to claim 1, wherein the analysis unit is configured to analyse, by means of a machine learning algorithm, the at least two different analysis regions both independently of each other and in combination for the presence of a faulty cable winding.

12. The device according to claim 1, wherein the analysis unit is configured to detect a condition of the cable in an uncoiled position in order to detect cable damage.

13. A working machine having the device according to claim 1 and having a display unit on which recordings from the at least one sensor unit and/or information relating to a faulty cable winding and/or condition of the cable recognised by the analysis unit can be displayed.

14. A method for monitoring a winding behaviour of the cable on the cable winch of the device according to claim 1, wherein the two-dimensional images of the cable coils on a cable drum of the cable winch are captured, wherein the at least two different analysis regions, each imaging at least one cable winch in whole or in part, are defined in the images and are analysed independently of one another for the presence of a defective cable coil.

15. A computer program product, comprising instructions that, upon execution of the program, cause the device to execute the method according to claim 14.

16. The device according to claim 4, wherein two analysis regions of the at least two different analysis regions comprise mutually opposite radial edge regions of the imaged cable drum and each extend over the entire axial length of the cable drum.

17. The working machine according to claim 13, wherein the working machine is a crane, a civil engineering machine, or a cable excavator.

18. The working machine according to claim 13, wherein the cable winch is a hoisting cable winch or a tensioning cable winch.

19. The device according to claim 1, wherein the cable winch is a multi-layer winch.

20. The device according to claim 3, wherein the recording direction of the at least one sensor unit is perpendicular to a cable portion extending tangentially from the cable drum.
